(19) United States
(12) Patent Application Publication
(10) Pub. No.: US 2022/0049545 A1
(43) Pub. Date: Feb. 17, 2022

(54) Power Generating Blind Assembly

(71) Applicant: Thuytrinh Pham, Fresno, CA (US)

(72) Inventor: Thuytrinh Pham, Fresno, CA (US)

(21) Appl. No.: 16/991,107

(22) Filed: Aug. 12, 2020

(51) Int. Cl. E06B 9/386; E06B 9/264; E06B 9/32

(52) U.S. Cl. CPC E06B 9/386; E06B 2009/2476; E06B 9/32; E06B 9/264

(57) ABSTRACT

A power generating blind assembly for harnessing solar energy passing through a window includes a set of window blinds for mounting in a window. The set of window blinds includes an upper housing, a lower member and a plurality of slats. A plurality of solar cells is each positioned on a respective one of the slats to be exposed to sunlight passing through the window. An adjustment unit is integrated into the set of window blinds and the adjustment unit adjusts an angle of the plurality of slats. In this way the adjustment unit facilitates the plurality of solar cells to capture the maximum amount of solar energy.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to window blind devices and more particularly pertains to a new window blind device for harnessing solar energy passing through a window.

### (2) Description of Related Art Including Information Disclosed Under 37 CFR 1.97 and 1.98

The prior art relates to window blind devices including an HVAC controller that is in communication with a personal electronic device. The prior art discloses a variety of window blinds that include a motor for automatically adjusting the angle of slats in the window blinds. The prior art discloses a photovoltaic sheet that is integrated into windows of a building for harnessing solar energy. The prior art also window that has photovoltaic cells integrated therein that are arranged at a perpendicular angle to a surface of the window. The prior art discloses a building that employs solar energy for heating and cooling purposes. The prior art discloses a window shade system that includes a solar panel positioned on a slat.

### BRIEF SUMMARY OF THE INVENTION

An embodiment of the disclosure meets the needs presented above by generally comprising a set of window blinds for mounting in a window. The set of window blinds includes an upper housing, a lower member and a plurality of slats. A plurality of solar cells is each positioned on a respective one of the slats to be exposed to sunlight passing through the window. An adjustment unit is integrated into the set of window blinds and the adjustment unit adjusts an angle of the plurality of slats. In this way the adjustment unit facilitates the plurality of solar cells to capture the maximum amount of solar energy.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front phantom view of a power generating blind assembly according to an embodiment of the disclosure.

FIG. 2 is a back phantom view of an embodiment of the disclosure.

FIG. 3 is a left side phantom view of an embodiment of the disclosure.

FIG. 4 is a perspective in-view of an embodiment of the disclosure.

### DETAILED DESCRIPTION OF THE INVENTION

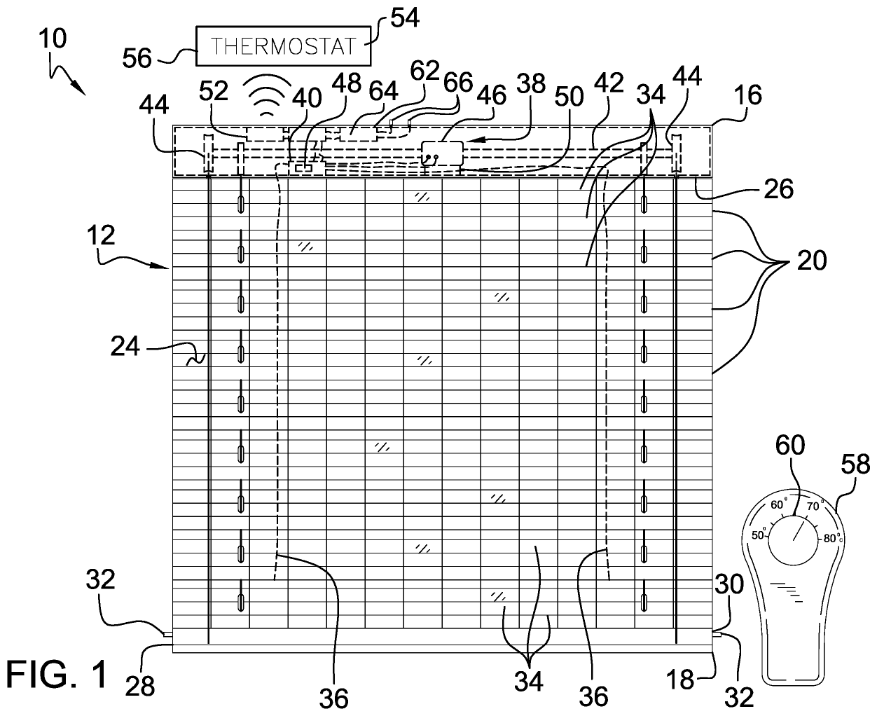

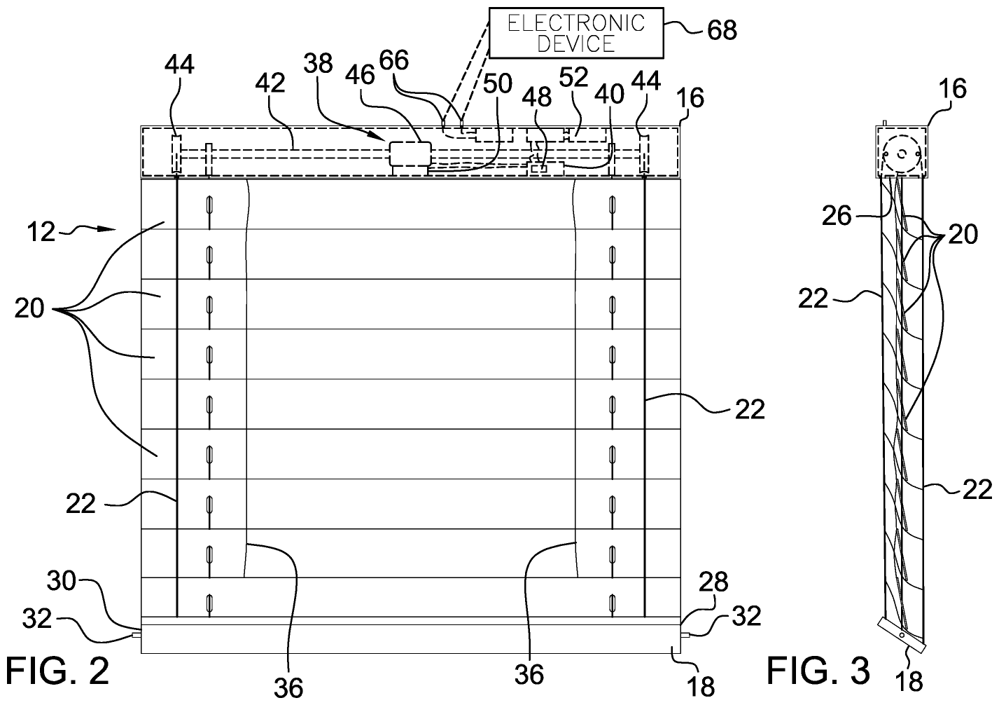

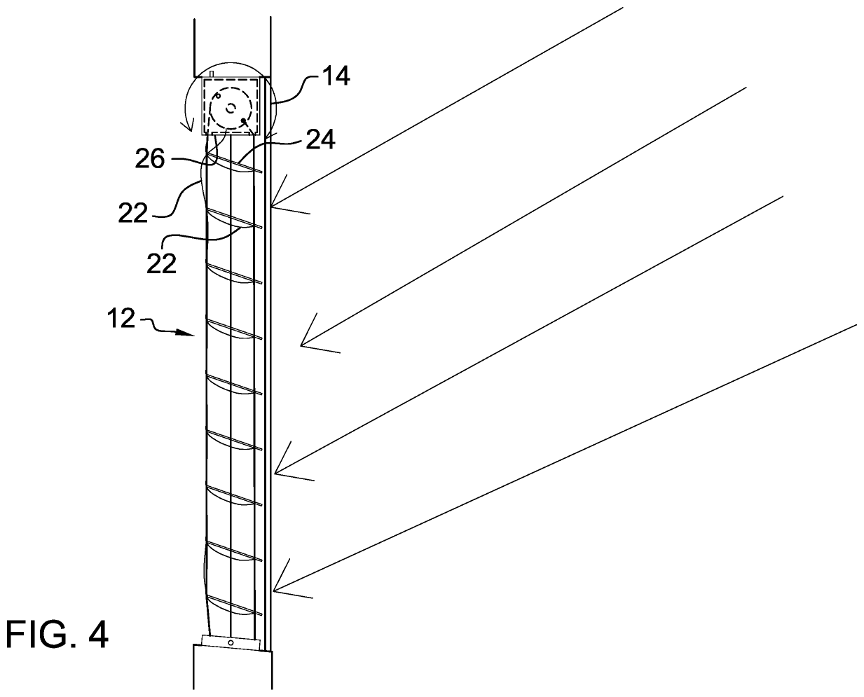

With reference now to the drawings, and in particular to FIGS. 1 through 4 thereof, a new window blind device embodying the principles and concepts of an embodiment of the disclosure and generally designated by the reference numeral 10 will be described.

As best illustrated in FIGS. 1 through 4, the power generating blind assembly 10 generally comprises a set of window blinds 12 that can be mounted in a window 14. The window 14 may be a window in an exterior wall of a building, including but not being limited to, a residence or an office. The set of window blinds 12 includes an upper housing 16, a lower member 18 and a plurality of slats 20 being distributed between the upper housing 16 and the lower member 18.

Additionally, the set of window blinds 12 includes a plurality of adjustment lines 22. Each of the adjustment lines 22 extends between the upper housing 16 and the lower member 18 and each of the adjustment lines 22 engages each of the slats 20 for adjusting an angle of the slats 20. Moreover, each of the slats 20 has a top surface 24 and each of the slats 20 is adjustable such that the top surface 24 of each of the slats 20 is oriented to lie on a plane forming an angle with a lower side 26 of the upper housing 16. The lower member 18 has a first end 28 and a second end 30, and a pair of pins 32 is each coupled to and extends away from a respective one of the first end 28 and the second end 30. Each of the pins 32 might engage a track, or other similar structure, that is integrated into a frame of the window 14 for retaining the lower member 18 at a preferred location.

A plurality of solar cells 34 is provided and each of the solar cells 34 is positioned on a respective one of the slats 20. In this way each of the solar cells 34 can be exposed to sunlight passing through the window 14. Additionally, each of the solar cells 34 is positioned on the top surface 24 of the respective slat 20 having the solar cells 34 on the respective slat 20 completely cover the top surface 24 of the respective slat 20. A plurality of conductors 36 is each electrically coupled to each of the solar cells 34 on each of the slats 20 and each of the conductors 36 extends into the upper housing 16.

An adjustment unit 38 is provided and the adjustment unit 38 is integrated into the set of window blinds 12. The adjustment unit 38 is in mechanical communication with the plurality of slats 20. Moreover, the adjustment unit 38 adjusts an angle of the plurality of slats 20 to facilitate the plurality of solar cells 34 to capture the maximum amount of solar energy. The adjustment unit 38 comprises a control circuit 40 that is positioned in the upper housing 16. The control circuit 40 is electrically coupled to each of the conductors such that the control circuit 40 is in electrical communication with the plurality of solar cells 34.

The adjustment unit 38 includes a drive shaft 42 that is rotatably positioned within the upper housing 16 and a pair of pulleys 44. Each of the pulleys 44 has the drive shaft 42 extending therethrough and the pulleys 44 are spaced apart from each other on the drive shaft 42. Additionally, each of the pulleys 44 has a respective one of the adjustment lines 22 being wrapped therearound. The adjustment unit 38 includes a motor 46 that is positioned in the upper housing 16 and the motor 46 is electrically coupled to the control circuit 40. The motor 46 rotatably engages the drive shaft 42 and the motor 46 rotates the drive shaft 42 in a first direction or a second direction. Each of the slats 20 is tilted in a first direction when the motor 46 rotates the drive shaft 42 in the first direction and each of the slats 20 is tilted in a second direction when the motor 46 rotates the drive shaft 42 in the second direction. The motor 46 may comprise a bi-directional electric motor or the like.

The adjustment unit 38 includes a signal analyzer 48 that is positioned in the upper housing 16. The signal analyzer 48 is electrically coupled to the control circuit 40 such that the signal analyzer 48 is in electrical communication with the plurality of solar cells 34. The motor 46 is actuated to rotate in either the first direction or the second direction until the signal analyzer 48 determines the point at which the plurality of solar cells 34 produces the highest intensity of output. In this way the signal analyzer 48 ensures each of the slats 20 is positioned at the optimal angle for exposing the solar cells 34 to sunlight.

A thermometer 50 is provided and the thermometer 50 is coupled to the set of window blinds 12. In this way the thermometer 50 is in thermal communication with the window 14 in which the set of window blinds 12 is positioned. The thermometer 50 is electrically coupled to the control circuit 40. Additionally, the thermometer 50 may comprise an electronic thermometer 50 of any conventional design.

A transceiver 52 is positioned in the housing and the transceiver 52 is electrically coupled to the control circuit 40. Moreover, the transceiver 52 is in wireless communication with a thermostat 54 of a heating, ventilation and air conditioning (HVAC) system 56. In this way the transceiver 52 facilitates the HVAC system 56 to respond to the temperature sensed by the thermometer 50. Thus, the HVAC system 56 can increase cooling capacity when the thermometer 50 senses temperatures that exceed a pre-determined threshold temperature. The transceiver 52 may comprise a radio frequency transceiver or the like. As is shown in FIG. 1, a remote control 58 may be provided that includes a temperature knob 60 for selecting a temperature between a minimum temperature and a maximum temperature. Additionally, the remote control 58 may be in wireless communication with the thermostat 54 of the HVAC system 56. The angle of the slats 20 may be adjusted in accordance to the temperature selected with the temperature knob 60 on the remote control 58 for either increasing or decreasing the amount of sunlight that passes through the slats 20.

A power supply 62 is positioned in the upper housing 16 and the power supply 62 is electrically coupled to the control circuit 40. The power supply 62 comprises at least one battery 64 to store electrical energy produced by the plurality of solar cells 34. The power supply 62 includes a pair of contacts 66 that is each of the contacts 66 is coupled to and extends away from the upper housing 16. In this way each of the contacts 66 can be electrically coupled to an electronic device 68. Additionally, each of the contacts 66 is electrically coupled to the at least one battery 64 to deliver electrical energy to the electronic device 68.

In use, the signal analyzer 48 continually monitors the output of the plurality of solar cells 34 and the slats 20 are adjusted to the optimal angle for maximizing the electrical energy produced by the solar cells 34. The at least one battery 64 stores the electrical energy produced by the solar cells 34 and the contacts 66 can supply the electrical energy to an electronic device 68. Additionally, the thermometer 50 measures the temperature of the window 14 and the transceiver 52 communicates the temperature to the thermostat 54 of the HVAC system 56. In this way the HVAC system 56 can increase or decrease cooling or heating output, depending on the preferences set by a user, in response to the temperature sensed by the thermometer 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A power generating blind assembly for generating electrical current and shading a window, said assembly comprising:
a set of window blinds being configured to be mounted in a window, said set of window blinds including an upper housing, a lower member and a plurality of slats being distributed between said upper housing and said lower member;
a plurality of solar cells, each of said solar cells being positioned on a respective one of said slats wherein each of said solar cells is configured to be exposed to sunlight passing through the window;
an adjustment unit being integrated into said set of window blinds, said adjustment unit being in mechanical communication with said plurality of slats, said adjustment unit adjusting an angle of said plurality of slats wherein said adjustment unit is configured to facilitate said plurality of solar cells to capture the maximum amount of solar energy;
a thermometer being coupled to said set of window blinds wherein said thermometer is configured to be in thermal communication with the window in which said set of window blinds is positioned; and
a transceiver being positioned in said housing, said transceiver being in wireless communication with a thermostat of a heating, ventilation and air conditioning (HVAC) system wherein said transceiver is configured to facilitate the HVAC system to respond to the temperature sensed by said thermometer.

2. The assembly according to claim 1, wherein said set of window blinds includes a plurality of adjustment lines, each of said adjustment lines extending between said upper housing and said lower member having each of said adjustment lines engaging each of said slats for adjusting an angle of said slats.

3. The assembly according to claim 1, wherein:
each of said slats has a top surface, each of said slats being adjustable such that said top surface of each of said slats is oriented to lie on a plane forming an angle with a lower side of said upper housing; and
each of said solar cells is positioned on said top surface of said respective slat.

4. The assembly according to claim 3, wherein:
said assembly includes a plurality of conductors, each of said conductors being electrically coupled to each of said solar cells on each of said slats, each of said conductors extending into said upper housing; and
said adjustment unit comprises a control circuit being positioned in said upper housing, said control circuit being electrically coupled to each of said conductors such that said control circuit is in electrical communication with said plurality of solar cells.

5. The assembly according to claim 4, wherein:
said set of window blinds includes a plurality of adjustment lines, each of said adjustment lines extending between said upper housing and said lower member having each of said adjustment lines engaging each of said slats for adjusting an angle of said slats; and
said adjustment unit includes:
a drive shaft being rotatably positioned within said upper housing;
a pair of pulleys, each of said pulleys having said drive shaft extending therethrough, said pulleys being spaced apart from each other on said drive shaft, each of said pulleys having a respective one of said adjustment lines being wrapped therearound; and
a motor being positioned in said upper housing, said motor being electrically coupled to said control circuit, said motor rotatably engaging said drive shaft, said motor rotating said drive shaft in a first direction or a second direction, each of said slats being tilted in a first direction when said motor rotates said drive shaft in said first direction, each of said slats being tilted in a second direction when said motor rotates said drive shaft in said second direction.

6. The assembly according to claim 5, wherein said adjustment unit includes a signal analyzer being positioned in said upper housing, said signal analyzer being electrically coupled to said control circuit such that said signal analyzer is in electrical communication with said plurality of solar cells.

7. The assembly according to claim 6, wherein said motor is actuated to rotate in either said first direction or said second direction until said signal analyzer determines the point at which said plurality of solar cells produces the highest intensity of output wherein said signal analyzer is configured to ensure each of said slats is positioned at the optimal angle for exposing said solar cells to sunlight.

8. The assembly according to claim 3, further comprising a power supply being positioned in said upper housing, said power supply being electrically coupled to said control circuit, said power supply comprising at least one battery wherein said at least one battery is configured to store electrical energy produced by said plurality of solar cells.

9. The assembly according to claim 8, further comprising a pair of contacts, each of said contacts being coupled to and extending away from said upper housing wherein each of said contacts is configured to be electrically coupled to an electronic device, each of said contacts being electrically coupled to said battery wherein each of said contacts is configured to deliver electrical energy to the electronic device.

10. A power generating blind assembly for generating electrical current and shading a window, said assembly comprising:
a set of window blinds being configured to be mounted in a window, said set of window blinds including an upper housing, a lower member and a plurality of slats being distributed between said upper housing and said lower member, said set of window blinds including a plurality of adjustment lines, each of said adjustment lines extending between said upper housing and said lower member having each of said adjustment lines engaging each of said slats for adjusting an angle of said slats, each of said slats having a top surface, each of said slats being adjustable such that said top surface of each of said slats is oriented to lie on a plane forming an angle with a lower side of said upper housing;
a plurality of solar cells, each of said solar cells being positioned on a respective one of said slats wherein each of said solar cells is configured to be exposed to sunlight passing through the window, each of said solar cells being positioned on said top surface of said respective slat;
a plurality of conductors, each of said conductors being electrically coupled to each of said solar cells on each of said slats, each of said conductors extending into said upper housing;
an adjustment unit being integrated into said set of window blinds, said adjustment unit being in mechanical communication with said plurality of slats, said adjustment unit adjusting an angle of said plurality of slats wherein said adjustment unit is configured to facilitate said plurality of solar cells to capture the maximum amount of solar energy, said adjustment unit comprising:
a control circuit being positioned in said upper housing, said control circuit being electrically coupled to each of said conductors such that said control circuit is in electrical communication with said plurality of solar cells;
a drive shaft being rotatably positioned within said upper housing;
a pair of pulleys, each of said pulleys having said drive shaft extending therethrough, said pulleys being spaced apart from each other on said drive shaft, each of said pulleys having a respective one of said adjustment lines being wrapped therearound;
a motor being positioned in said upper housing, said motor being electrically coupled to said control circuit, said motor rotatably engaging said drive shaft, said motor rotating said drive shaft in a first direction or a second direction, each of said slats being tilted in a first direction when said motor rotates said drive shaft in said first direction, each of said slats being tilted in a second direction when said motor rotates said drive shaft in said second direction; and
a signal analyzer being positioned in said upper housing, said signal analyzer being electrically coupled to said control circuit such that said signal analyzer is in electrical communication with said plurality of solar cells, said motor being actuated to rotate in either said first direction or said second direction until said signal analyzer determines the point at which said plurality of solar cells produces the highest intensity of output wherein said signal analyzer is configured to ensure each of said slats is positioned at the optimal angle for exposing said solar cells to sunlight;
a thermometer being coupled to said set of window blinds wherein said thermometer is configured to be in thermal communication with the window in which said set of window blinds is positioned, said thermometer being electrically coupled to said control circuit;
a transceiver being positioned in said housing, said transceiver being electrically coupled to said control circuit, said transceiver being in wireless communication with a thermostat of a heating, ventilation and air conditioning (HVAC) system wherein said transceiver is configured to facilitate the HVAC system to respond to the temperature sensed by said thermometer;
a power supply being positioned in said upper housing, said power supply being electrically coupled to said control circuit, said power supply comprising at least one battery wherein said at least one battery is configured to store electrical energy produced by said plurality of solar cells; and
a pair of contacts, each of said contacts being coupled to and extending away from said upper housing wherein each of said contacts is configured to be electrically coupled to an electronic device, each of said contacts being electrically coupled to said battery wherein each of said contacts is configured to deliver electrical energy to the electronic device.
